(19) United States
(12) Patent Application Publication
(10) Pub. No.: US 2019/0122123 A1
(43) Pub. Date: Apr. 25, 2019

(54) Process of Identifying Likely Lone Wolf Actors from Granular General or Targeted Populations

(71) Applicant: Clifford Mark, Potomac, MD (US)

(72) Inventor: Clifford Mark, Potomac, MD (US)

(21) Appl. No.: 15/790,610

(22) Filed: Oct. 23, 2017

(51) Int. Cl. G06N 5/02; G06F 17/30; G06N 99/00; G06F 17/15; G06Q 50/26; G06F 17/16; H04L 29/08

(52) U.S. Cl. CPC G06N 5/02; G06F 17/30702; G06F 17/30867; H04L 67/306; G06F 17/15; G06Q 50/265; G06F 17/16; G06N 99/005

(57) ABSTRACT

The present invention is a process of Identifying potential Lone Wolf Actors from granular general populations. This process utilizes evolving and emerging datasets and detects pertinent high-confidence patterns that emerge using mathematical analysis by persons and/or artificial intelligence pattern matching. This system attempts to be both extremely accurate and flexible which allows it to match emerging patterns with complete or incomplete data. The distillation of pattern matching produces continuously evolving algorithms or matrix attribulation tables which can be used to examine gathered or provided data sets to produce an output that provides insight into the matching of the individual to continuous markers which are highly correlating of lone wolf actors. This output data can be an algorithm, vector, or matrix which can be compared to others in the population. Statistical outliers can be examined from this using various mathematical and statistical methods and models.

### BACKGROUND

Since before Sep. 11, 2001 various systems have been in place to attempt to detect and thwart terrorism. These existing systems use a top down approach, are triggered at certain events, and/or rely on communications. These existing systems look for communication to and from certain groups, or visit known topical hubs and attempt to gain increased resolution on potential actors from a top-down view, other existing systems look at communication with known groups, or by identifying specifically hypothesized actions which are gleaned from hindsight or intelligence (e.g. tradecraft, tips, detective work). Other systems identify likely actors by their travel or payment information. These existing systems have shown to be effective against large scale attacks but they lose efficacy at preventing small scale terrorists actions which are often carried out by individual or small groups of people (e.g. citizens, immigrants, refugees) and require little funding. Lone Wolf terrorism is used to describe these small attacks, wherein a very small group or an individual carry out a small act of terrorism that targets often soft targets using methods that are difficult to thwart or detect.

### SUMMARY OF THE INVENTION

The objective of the present invention is to detect Lone Wolf Actors by a process of Identifying potential Lone Wolf Actors from Granular Populations using holistic analysis of Lone Wolf actors from all known factors of their life then processing or compressing these groups to discern highly correlating actions and resulting in equations which can provide insight into the probability of general population members of committing Lone Wolf Acts to varying degrees of confidence. This invention dictates the process of examining individuals of specified or general populations and determines if they are likely to commit Lone Wolf Acts. This present process is novel as opposed to previous systems which instead examine groups, topical hubs, or forums, and attempt to gain greater resolution which is the common existing process (of examining known groups, forums and topical hubs and gaining greater resolution of its individual members). This present invention of a process of Identifying Lone Wolf from Granular Populations determines if someone is likely to be commit a lone wolf act by comparing known lone wolf actor's public information and internet activity against a general population group to see if there are similarities within specified thresholds.

This process utilizes evolving and emerging datasets and detects pertinent high-confidence patterns that emerge using mathematical analysis by persons and/or artificial intelligence pattern matching. This system attempts to be both extremely accurate and flexible which allows it to match emerging patterns. The data sets can be flexible or fixed. The distillation of pattern matching produces continuously evolving algorithms or matrix attribulation tables which can be used to examine gathered or provided data sets which produce an output that provides insight into the matching of the individual to markers which are highly correlating of lone wolf actors. This output data can be a vector or matrix which can be compared to others in the population. Statistical outliers can be examined from this using various mathematical and statistical methods and models.

### BRIEF DESCRIPTION OF THE DRAWINGS

FIG. 1

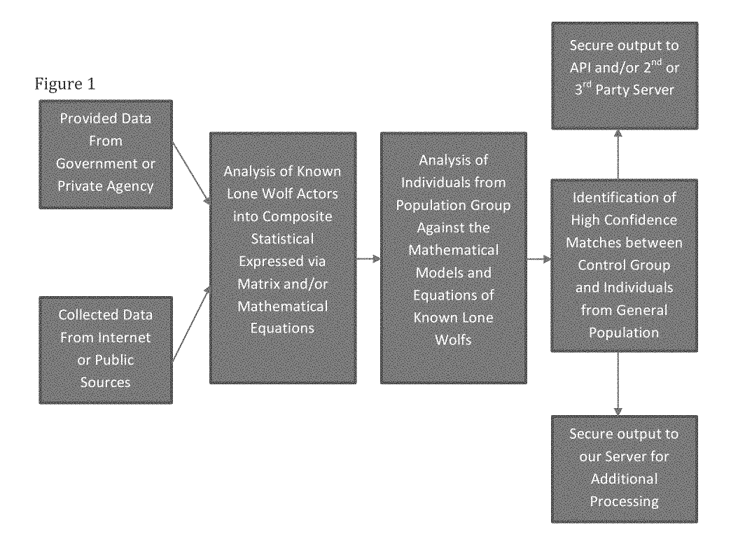

This process works with either provided data or gathered data with the assumption that with enough data high-confidence profiles can be matched for Lone Wolf Actors. Data can be provided or gathered, then analyzed to find patterns between control groups and then from that composite against general populations. This output data can be further examined to accentuate outliers, and can be processed for humans or additional machine use, such as an API plug-in to an existing system. This output can be delivered directly to a 2^{nd} or 3^{rd} party or be stored on our system.

FIG. 2

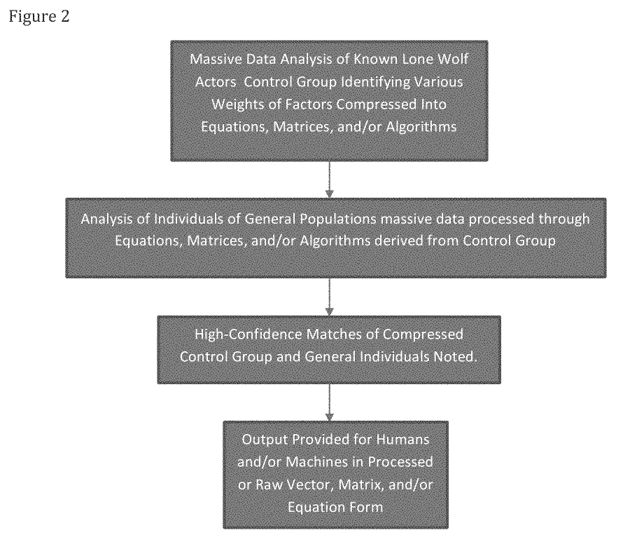

This invention is different from other methods because it indiscriminately analyzes general populations and utilizes mathematical models and machine pattern matching to establish variant weights to analyze the individuals against a composite of individuals in a control group of previous Lone Wolf Actors.

FIG. 3

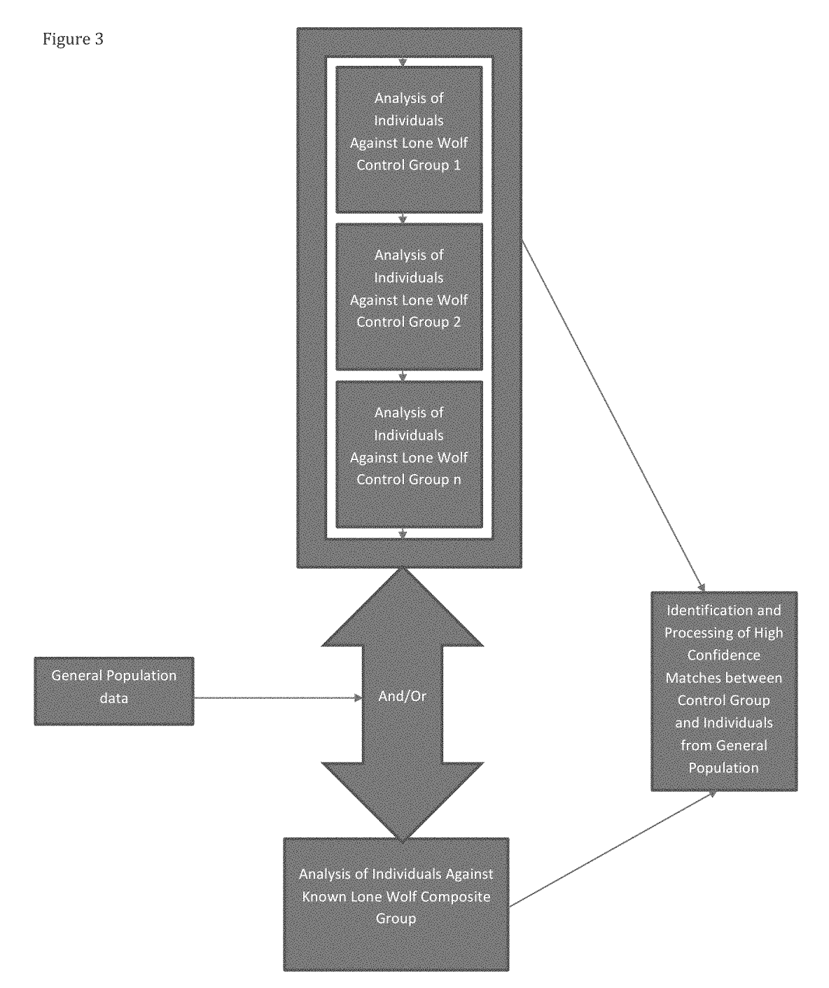

The process can be run in one pass against an equation or matrix representing a comprehensive composite of Lone Wolf Actors or it may be run against smaller control groups (for example the control group may be comprised of only successful or all Lone Wolf Actors from a various regions or groups). This present invention may utilize multiple iterations comparing against smaller Lone Wolf control groups to enhance pattern matching or processing performance or efficacy.

FIG. 4

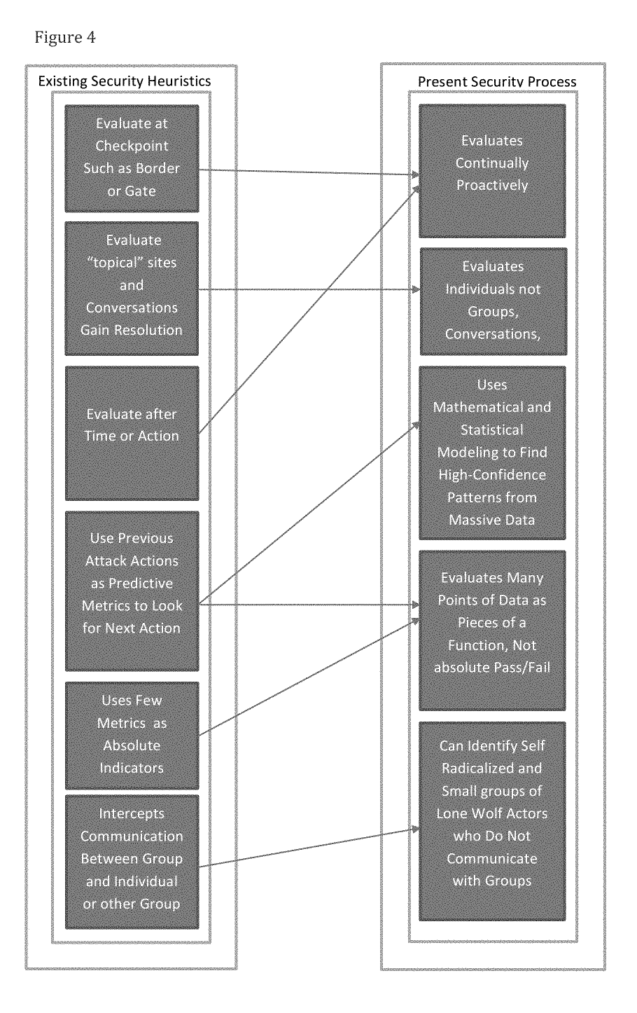

There are several distinct differences between previous security heuristics and this present invention which make the invention non-obvious and not necessarily an evolution from any existing security heuristic. In the first column there are pictorial representation of existing heuristics and the second column to the right depicts the heuristics in the present invention. The lines between the two columns help illustrate the relationship between old and new methods.

### DETAILED DESCRIPTION

The Process of finding those who are likely to match paradigms has been used in digital advertising to identify products or services people may be interested in by utilizing limited datasets including previous searches and pages they have viewed. The process of compressing complex information into smaller data utilizing algorithms has been used for years in music, video and photos and general data. This process expands upon the marketing ideas of “paradigms” or “profiles” which attempt to identify various users interests and personal identification which use smaller datasets with compression algorithms with the aim of finding those with similar “paradigms” to those who have committed previous acts of lone wolf acts. This present process compresses internet usage patterns of people into quickly processed equations then utilizes established statistical analysis to compare these compressed profiles against the predominate highly correlating equations of the composite “profiles” of those who have previously committed lone wolf acts. We can then identify to varying degrees the confidence interval.

These “paradigms” or “profiles” have proven successful at identifying likely user interest for targeted ads in various advertising platforms, perhaps most notably with google “adwords”. This present invention is a process which does not include gathering the data as the data can be gathered via previous inventions and methods which are established and perhaps notably which can all be public information. Whereas “adwords” and other advertising platforms need to access customer data and search history the present invention does not need such data and can use data which is all in the public domain. There is a Proof of Concept built that demonstrates the present invention which does not need to rely on private or non-public information. The novel nature at hands pertains to the process of compressing individuals of a general or specified population dataset and comparing them to a targeted highly correlative dataset that is also compressed for purposes of identifying actors of likely lone wolf terrorism or lone wolf acts and extracting usable insight from massive data analysis including pattern matching.

This data is often first compressed into matrix tables then manipulated using multiple established statistical, mathematical operations and then expressed in various equations often including differential equations. These equations are then optimized to be run on the currently available hardware structure to ensure quick data processing which allows these operations to be conducted against billions of individuals across trillions (or more) data points. The purpose of these operations is to identify and match population members to paradigms closely matching those of lone wolf actors. The specific mathematical operations are not detailed here because they have been utilized in previous inventions and will likely be refined overtime. It is anticipated that machine deep-learning will enhance the specific algorithms and even heuristics within the framework of the present invention.

This invention also presents data that is actionable by identifying varying degrees of lone wolf threat based on confidence interval of matching of the threat groups. Whereas statistical outliers of extreme match confidence interval are given non-linearly higher threat score.

This present invention utilizes several diverse established but non-proprietary processes and combines them in a novel way for a novel purpose.

1. The Process of Identifying Likely Lone Wolf Actors from General Population from the individual person level and not from a top down level looking at conversations, topical hubs, or similar using various weighting and correlative values which model control group of existing Lone Wolf Actors internet activities and profiles, and Public Information (henceforth Predictive Factors)

2. The Process of rating members of targeted or general populations based on their likelihood to match the Predictive Factors in various forms including weighting outliers in a non-linear progression expressed in vector, equation, and/or matrix format
